(19) United States
(12) Patent Application Publication
(10) Pub. No.: US 2003/0118123 A1
(43) Pub. Date: Jun. 26, 2003

(54) Methods and apparatus for transmitting and receiving data over a communications network in the presence of noise

(76) Inventors: John E. Hudson, Stansted (GB); Bassam M. Hashem, Nepean (CA)

Correspondence Address: Willilam M. Lee, Jr., LEE, MANN, SMITH, MCWILLIAMS, SWEENEY & OHLSON, P.O. Box 276, Chicago, IL, 60690-2786, US

(21) Appl. No.: 10/032,419

(22) Filed: Dec. 21, 2001

(51) Int. Cl. H04L 27/04; H04L 27/20

(52) U.S. Cl. 375/295; 375/308

(57) ABSTRACT

It is becoming increasingly important to improve data throughput in wireless networks. By transmitting data simultaneously at different modulation amplitudes and/or using different code strengths, terminals having different carrier to noise ratios are able to decode the different amplitude levels with varying degrees of success. This allows distant terminals to receive low data rate transmissions at high modulation levels or code rates while nearer terminals can use additional capacity in the transmission by receiving lower level modulation signals or code rates. In this way, distant terminals do not degrade overall network performance. By arranging for terminals to acknowledge receipt of data, re-transmission at different modulation levels or code rates may be carried out by the base station in order to improve performance in the presence of noise without a priori knowledge of the carrier to noise ratio for a particular terminal.

### FIELD OF THE INVENTION

This invention relates to methods of transmitting and receiving data over a communications network to a modulator and a demodulator, and to a transmitter.

### BACKGROUND OF THE INVENTION

Currently and no doubt in the future, considerable effort is being put into converting existing cellular mobile networks and designing future cellular mobile networks for high-capacity data transmission, Such data transmissions are required, for example, not only to service mobile terminals (for example to allow Internet access for laptop and PDA users) but also to provide broadband Internet access over a wireless local loop. As such, the data rates in such networks are considerably higher than had previously been required simply to transmit voice data.

Accordingly, maximised utilisation of base stations and spectrum in terms of data throughput in the network from the base stations to the terminals is an important goal in any new network design.

One approach which has been proposed by Qualcomm is so-called high data rate (HDR) technology. This technology takes advantage of the bursty nature of data transmissions by allocating each class of user (registered with a particular base station) a fractional time on any one channel. Within predetermined latency constraints (i.e. predetermined maximum times to transmit a predetermined number of bits to a terminal) the fractional time of a channel may be varied to dynamically alter the average data throughput to a particular terminal. This allows the network to provide high data rates for a terminal which instantaneously require high data rates and to reallocate that high data rate to another terminal when it is no longer required by the first terminal.

Although this approach is effective to at least some extent, one significant disadvantage of this technique is that network throughput is compromised by any terminal which is unable to receive data at high coding rates (for example because it has a poor carrier to noise ratio due to its distance from the base station and/or due to poor propagation characteristics in the radio channel between the base station and terminal). Thus if the terminal having a poor carrier to signal ratio requires a relatively large volume of data, a significant portion of the fractional time of a channel will be allocated to that terminal which will degrade the performance of other terminals.

### SUMMARY OF THE INVENTION

In accordance with a first aspect of the invention there is provided a method of transmitting data over a radio communications network comprising dividing the data into a plurality of distinct data streams, modulating each data stream into a single radio signal at different respective modulation levels, and transmitting the radio signal.

As is explained in more detail below, by modulating several different data streams (for example using QPSK modulation for each data stream) and simultaneously transmitting the data streams, terminals close to the base station are able to receive the signals modulated at lower amplitude and terminals having lower carrier to noise ratios (typically at further distances from the base station) are only able to demodulate the data streams modulated at high amplitude. In this way, rather than network throughput being compromised through terminals having differing carrier to noise signal ratios, this difference is turned to the network's advantage by allowing it to distinguish between different terminals.

As explained in more detail below, if each modulation level is applied as QPSK modulation at differing power levels (for example, reducing by half at each subsequent modulation) 64 QAM (quadrature amplitude modulation) modulation is produced.

In a second aspect, the invention provides a method of receiving data over a radio communications network, comprising receiving a radio signal carrying a plurality of data streams modulated at different respective modulation levels, and demodulating a first data stream from the signal, and attempting to demodulate at least one further data stream from the signal.

Thus each terminal attempts to demodulate as much of the signal as it can. This means that terminals having better carrier noise ratios are able to receive higher rate data.

In the example mentioned above of a plurality of overlapping QPSK modulations at differing amplitudes, a terminal may for example treat two overlapped QPSK modulations as a composite 16 QAM signal (depending on how it has been modulated at the transmitter). Thus depending on choices made at the base station, the different modulation levels may be used to direct different data streams to terminals in different zones (as defined by their respect carrier to noise ratios and therefore ability to demodulate the different amplitude levels of the transmitted signal) or to aggregate the different modulation levels to produce a composite signal of higher data rate.

Thus for example, a terminal near the base station is likely to be able to demodulate all levels of the transmitted signal. By choosing to provide data for that terminal on all levels, the data bandwidth for that terminal is maximised. Optionally, some of the higher levels amplitude levels may carry data destined for more distant terminals in which case the data throughput is shared between the near and far terminals. This is in contrast to the Qualcomm HDR solution in which a choice would need to be made between transmitting data at relatively low rates to the far terminal or at high rates to the near terminal.

As a further enhancement, a terminal may indicate that it has not received data This may be achieved for example by the base station waiting for a predetermined time for acknowledgement of data which it has transmitted or by a terminal requesting retransmission of data which it has been unable to decode accurately. In this way, a base station may choose how to retransmit data. For example, it may choose to retransmit the data at the same amplitude modulation level or at a greater modulation level. It may also choose to increase the strength of any forward error correction which is applied prior to transmission. Furthermore, the base station may use repetition odes of gradually increasing strength in order to ensure that eventually the terminal receives the data. Thus, the base station may adapt to the instantaneous carrier to noise levels experienced by the terminal and does not need a priori knowledge of the carrier to noise ratio (for example by receiving measurements taken by the terminal). This overcomes a problem particularly with 3G networks in which interference is bursty in nature (typically as a result of neighbouring terminals transmitting and receiving bursty data). Thus instantaneous measurements of carrier to noise ratio of the terminal do not provide an effective indicator of the needs of the terminals since the base station may not be able to use the measurements for several milliseconds (because it will be transmitting to other terminals) by which time the carrier to noise measurement is likely to be out of date.

In accordance with another aspect of the invention there is provided a data-bearing radio signal comprising a plurality of QPSK modulated data streams combined into a single QAM transmission, the combination being made by combining each QPSK signal at progressively smaller amplitude levels.

In a further aspect there is provided a modulator for a radio signal comprising a plurality of data inputs arranged to receive respective data streams, a modulator for applying modulation to a radio signal responsive to data received at each of the data inputs, the modulator being arranged to apply modulation at different respective amplitude levels for data received at respective data inputs.

The invention may also provide a radio transmitter having a plurality of data inputs arranged to receive respective data streams, and a modulator for applying modulation to a radio signal responsive to data received at each of the data inputs, the modulator being arranged to apply modulation at different respective amplitude levels for data received at respective data inputs.

In another aspect, the invention provides a demodulator arranged to demodulate a radio signal having a plurality of data streams modulated at different respective modulation levels.

In a further method aspect, the invention provides a method of transmitting data over a radio network to a plurality of terminals comprising modulating a signal for transmission with a plurality of respective data streams, selecting the modulation amplitude for each data stream according to the desired destination of each respective data stream, and simultaneously transmitting the data streams, whereby the data is simultaneously transmitted to selected terminals by virtue of their differing radio channel properties and distances from the transmitter.

Other aspects and features of the present invention will become apparent to those ordinarily skilled in the art upon review of the following description of specific embodiments of the invention in conjunction with the accompany figures.

### BRIEF DESCRIPTION OF THE DRAWINGS

FIG. 1 is a schematic diagram of a base station and different modulation levels;

FIG. 2 shows a three level QPSK modulation scheme;

FIG. 3 shows the detailed construction of the modulation scheme of FIG. 2;

FIG. 4 is a schematic diagram indicating a demodulation technique for the modulation of FIGS. 2 and 3;

FIG. 5 is a plot of bit error rate for the combined modulation of FIGS. 2 and 3;

FIG. 6 is a schematic diagram showing differing data rates for different terminal zones;

FIG. 7 is a schematic diagram showing modulation in accordance with the invention;

FIG. 8 is a schematic diagram showing an encoding scheme in accordance with the invention;

FIG. 9 is a schematic diagram showing a decoding scheme in accordance with the invention; and

FIG. 10 shows performance of transmissions in accordance with the invention against the ideal Shannon law maximised data rate.

### DETAILED DESCRIPTION OF THE INVENTION

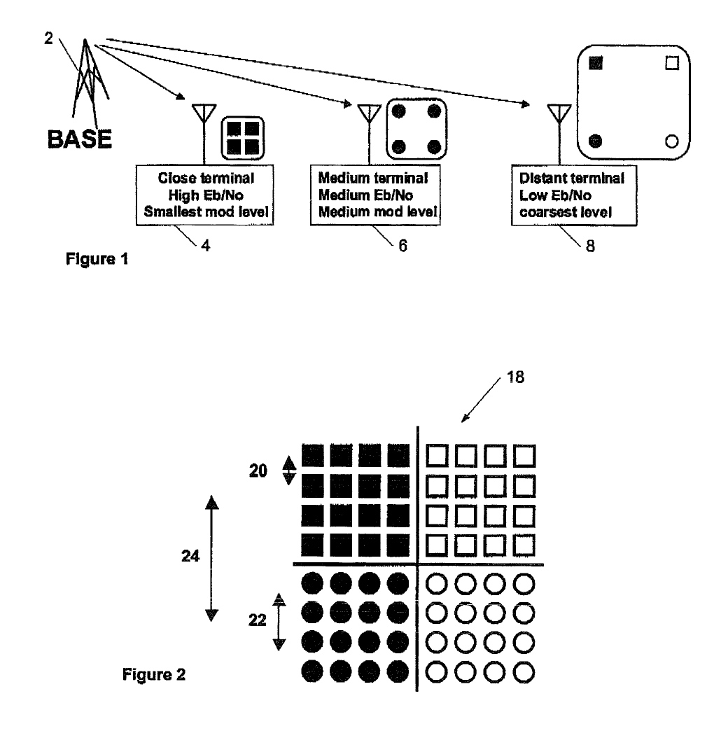

With reference to FIG. 1, a base station 2 (for example a 3G base station sending data packets) is arranged to transmit data to a plurality of terminals 4, 6 and 8 which are located at respectively increasing distances from the base station 2.

As a result of the differing distances between the respective terminals 4, 6 and 8 and the base station 2, the terminals experience different carrier to noise (Eb/No) ratios. Thus the closest terminal 4 (having the highest Eb/No) is able to demodulate signals which have been transmitted at lower amplitude by the base station 2 than the more distant terminals 6 or 8.

Thus as will be described in more detail below, the base station is arranged to transmit a signal which is modulated at several different amplitude levels. The highest amplitude modulation may for example, be the only modulation which the distant terminal 8 is able to demodulate, whereas the close terminal 4 is likely to be able to demodulate all modulation levels.

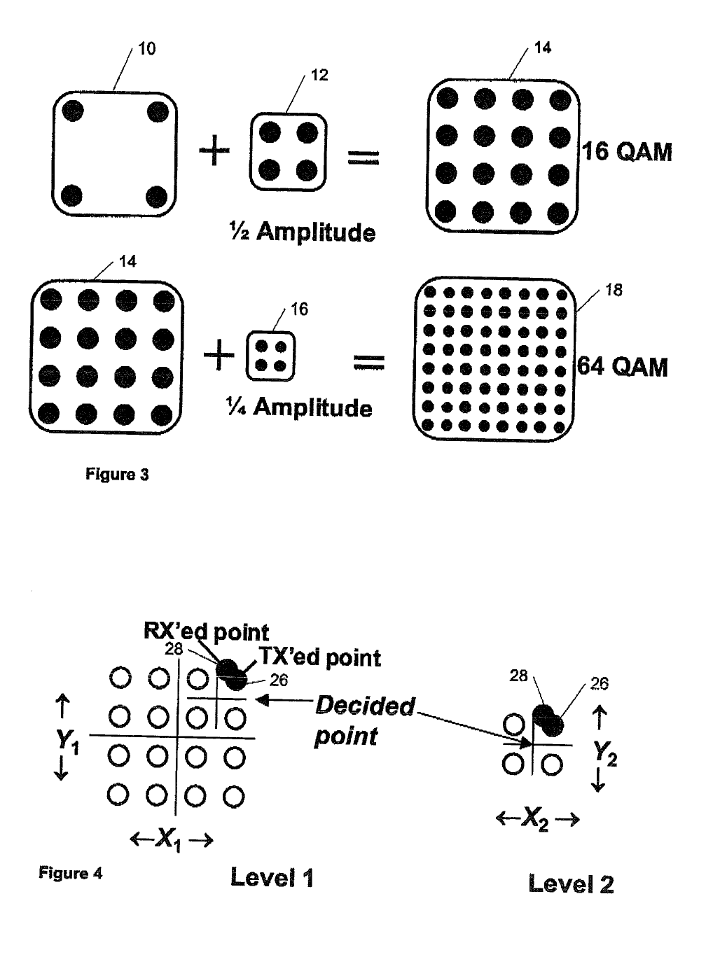

With reference to FIGS. 2 and 3, a possible modulation scheme is shown. A fundamental “layer 1” QPSK constellation 10, of unit amplitude is added to a layer 2 half amplitude QPSK constellation 12 with independent modulation. This produces a final constellation 14 which is 16 QAM.

Assuming that the two QPSK constellations 10 and 12 are orthogonal in a statistical sense since their modulations are uncorrelated, the variance of the 16 QAM modulation is equal to the sum of the variance of the two QPSK variants; namely 1+¼=1¼. Thus the 16 QAM modulation is 0.969 dB stronger than the unit amplitude QPSK 10.

The modulation may be carried to additional levels. For example, a further quarter amplitude QPSK signal 16 may be added to the 16 QAM signal to produce a three layer 64 QAM constellation 18. Similarly, if the QPSK signal 16 is uncorrelated with the other QPSK signals 10 and 12, the carrier power of the triple combination 18 is 1 +¼+1/16=1 5/16 or 1.181 dB. Thus the inclusion of additional information in the signal adds a relatively small amount to the carrier power requirements.

The resultant 64 QAM constellation 18 is shown in FIG. 2 with the respective amplitude modulations for the constellations 16, 12 and 10 shown by arrows 20, 22 and 24. As will be seen, the length of the arrows schematically represents the amplitude level of each of the respective modulations.

With reference now to FIG. 4, a technique for decoding the modulation shown in FIGS. 2 and 3 is now described.

At each terminal 4, 6 and 8, the same decoding procedure may be carried out. However, as will be described below, in view of the different Eb/No figures at the different terminals, not all terminals will be able to decode all levels of the modulation.

The process starts by treating the received signal (16 QAM for this example) as a simple QPSK signal. A polarity check is performed in the X and Y directions as shown in the left part of FIG. 4. As shown schematically, the transmitted point in the constellation 26 is actually received at point 28 due to noise. However, this is successfully demodulated as X₁=+1, Y₁=+1.

It is now necessary to determine which constellation point was transmitted within the second level modulation. Thus in a second stage, the ideal decided constellation point (+1, +1) at the level 1 modulation is subtracted from the received sample to produce a QPSK constellation as shown in the right side of FIG. 4. A further polarity check is then carried out on the residue to determine the second level of data which ideally is X₂=+½, Y₂=+½.

For third and subsequent modulation levels, the process is repeated so that for a third level, the ideal decided constellation point for both the preceding levels is subtracted from the received signal and a further polarity check carried out to determine the third level modulation. However, as will be noted from FIG. 4, noise has caused the receive point 28 to move from its ideal position as transmitted. Thus as the terminals 4, 6 and 8 receive the signal in the presence of increased noise (for example at further distance from the base station 2) it becomes increasingly difficult to decode the additional levels of modulation. Eventually, at further levels of modulation or at further distance from the base station, it will become impossible to decode one or more levels of modulation. Thus a graceful degradation in signal reception (and therefore bandwidth) occurs with decreasing Eb/No.

It is expected that forward error correction will be required. This is because the first level decision process is corrupted due to the presence of second and higher modulations because the minimum distance properties of any forward error (FEC) coding is “damaged”. In the example given above, the potential interference power from this source is (½)²+(½)⁴+(½)+(any subsequent modulation levels) which equals 0.33 recurring. This is only 5 dB lower than the power of the fundamental QPSK signal. Thus it will be typically be necessary to use a coding technique which is capable of operating below a carrier to noise ratio level of 5 dB.

FIG. 5 shows how this works in practice. Three plots are shown. The plots are for basic QPSK, of 16 QAM and 64 QAM respectively. In each case, the signal has been decoded only at the unit amplitude QPSK level (i.e. the first level). Thus it can be seen that the addition of the extra levels makes negligible difference to the bit error rate. This example was produced using a half rate turbo decoder with a constraint length of 6.

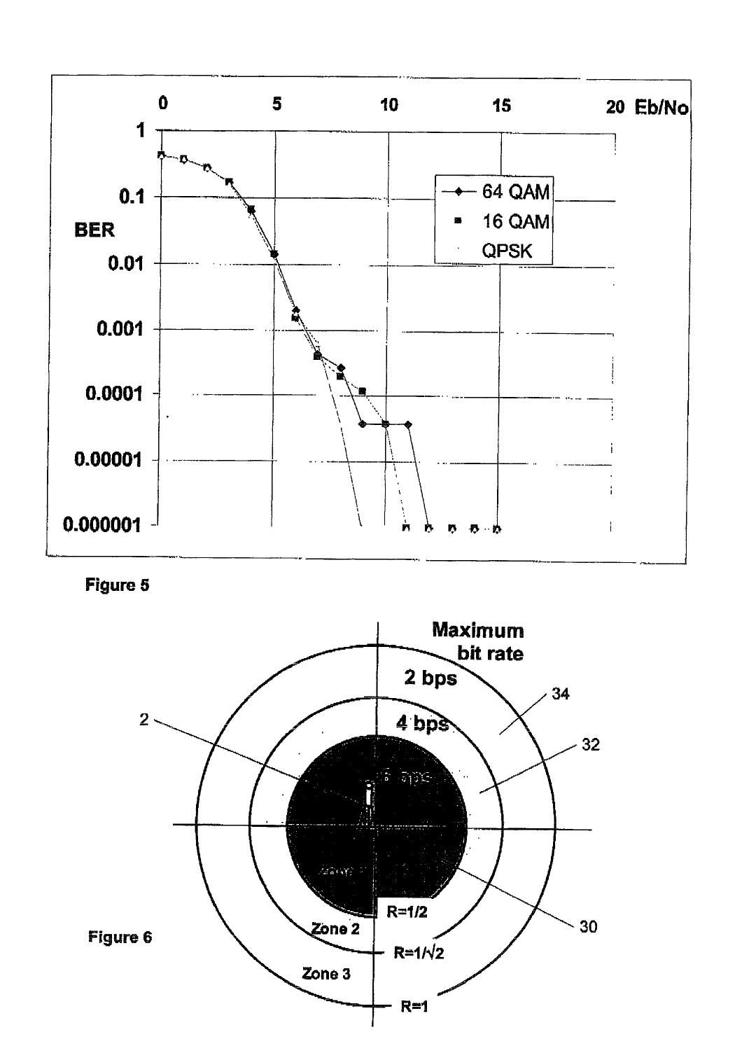

FIG. 6 shows the potential effects of using such a modulation technique.

In the figure, an R⁻⁴ propagation law has been assumed which is typical for a cellular radio base station. Thus transmitting the three layers of QPSK with carrier powers of 0, −6 and −12 dB and using similar strength FEC error correction on the three modulation levels, they will achieve a given BER at Eb/No levels differenced by 6 dB. Thus in a cellular system with an R⁻⁴ propagation law, the ratio of radii at which the Eb/No will differ by 6 dB is √2. Thus FIG. 6 shows the annuli in which the various layers will operate with differing bits per symbol. 64 QAM (6 bits/per symbol) can be operated in the centre zone 30 and 16 QAM can be operated in the intermediate zone 32 with a parallel third level of modulation still functional in the centre zone 30. In the outer zone 34, only QPSK (two bits/per symbol) can be used but the layer two modulation can be used in the intermediate zone 4 and both the higher layers can be decoded in the central zone 30. Thus there is considerable flexibility in the allocation of bit rate to zones.

For example, the maximum possible capacity may be used in the intermediate zone 32. In this case, the intermediate zone 32 may receive a maximum of four bits per symbol (using the level 1 and 2 modulations shown in FIG. 3 as QPSK modulations 10 and 12) which provide a combination of four bits per symbol. At the same time, the inner zone 30 may receive level three QPSK at two bits per symbol.

In a second scenario, the maximum bit rate may be provided to the central zone 30. In this case, all three QPSK levels are decoded in the central zone providing a maximum bit rate of six bits per symbol.

A third scenario is simply to allocate the highest modulation QPSK (level one) to the outer zone 34, the next level modulation to the intermediate zone 32 and the lowest level modulation (reference 16 in FIG. 3) to the inner zone 30. In this case, all zones receive data at two bits per symbol. However, it will be appreciated that the areas of the zones are not equal (and in the example shown in FIG. 6, the areas are in the ratios ¼, ¼, and 1/2 moving out from the centre). Thus considered in per unit area terms, subscribers in the outer zone 34 receive only half the bit rates of those in the inner and intermediate zones 30 and 32.

The choice between the scenarios may be made at the design stage or may be made dynamically by the base station in response to the instantaneous bandwidth requirements of the terminals.

It will be particularly appreciated by those skilled in the art that the presence of distant terminals having low Eb/No does not prevent terminals having higher Eb/No using additional capacity in the radio network. This is shown, for example, in scenario two in which a terminal in the intermediate zone 32 is able to receive its maximum possible data rate of four bits per second without preventing a terminal in the central zone 30 from receiving the additional two bits per symbol capacity present In the radio network.

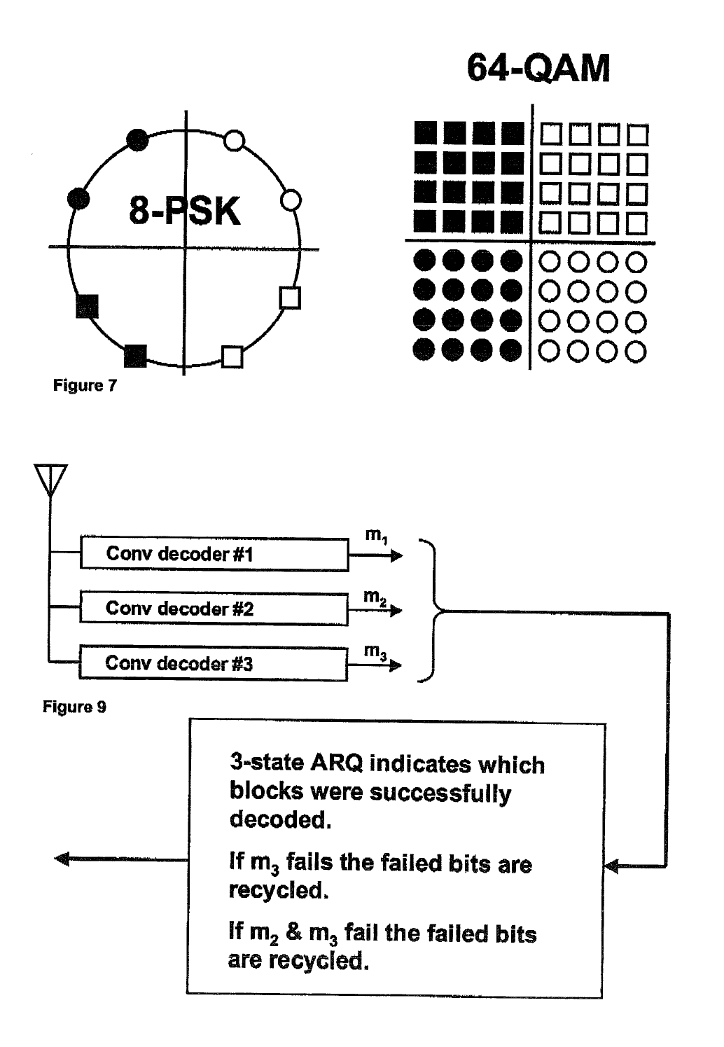

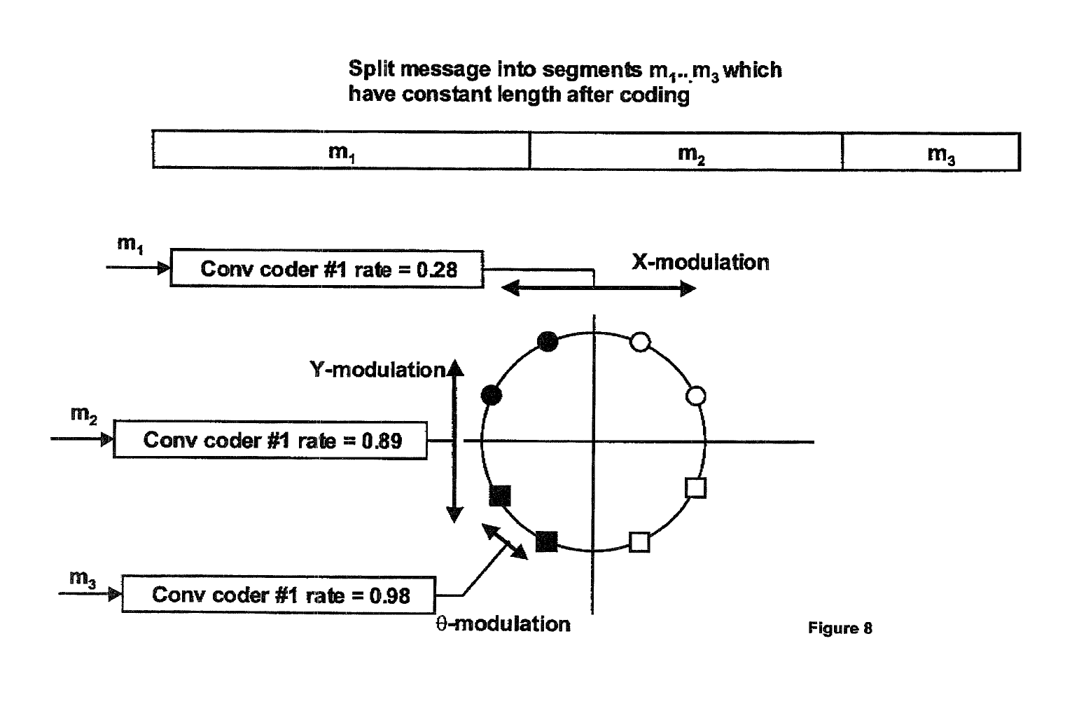

FIGS. 7 and 8 show schematically a possible coding scheme. An 8-PSK phase diagram is shown on the left of FIG. 7. With particular reference to FIG. 8, an incoming date stream may be split into message segments m₁, m₂ and m₃. These are coded at different rates and the length of the pre-coded segments are chosen to provide constant length after coding. Thus as shown, message segment m₁ is coded at a rate of 0.28, message segment m₂ is coded at a rate of 0.89 and message segment m₃ is coded at a rate of 0.98. These modulations are applied respectively as X modulation, Y modulation and angular modulation θ. The different code rates provide different error protections for the data which is equivalent to the different amplitude modulation levels of the previous example.

At the terminal, the terminal is arranged to acknowledge receipt of data once successfully decoded. Thus with reference to FIG. 9, each terminal carries out convolutional decoding of the three differently coded blocks and acknowledges blocks which were successfully decoded. If, for example, the message segment 3 (transmitted at the highest code rate) is not decoded then the transmitter recycles the failed bits and re-transmits them. Similarly, if message segments 2 and 3 are not successfully decoded then a re-transmission request is issued to the base station.

The base station may choose to re-transmit the recycled bits using the same coding strength as the original transmission. Alternatively, the base station may take steps to ensure that there is a better chance of accurate reception by the terminal. This may, for example, be to re-transmit the data at a higher code rate within the multi-level structure described above. A combination of these techniques may be applied so that re-transmission requests may be used with either or both a differential code strength scheme or a differential modulation scheme. For example, the coding strength may only be increased when the base station is already transmitting the signal at the highest modulation level (i.e. the unity amplitude QPSK level 10 or FIG. 3).

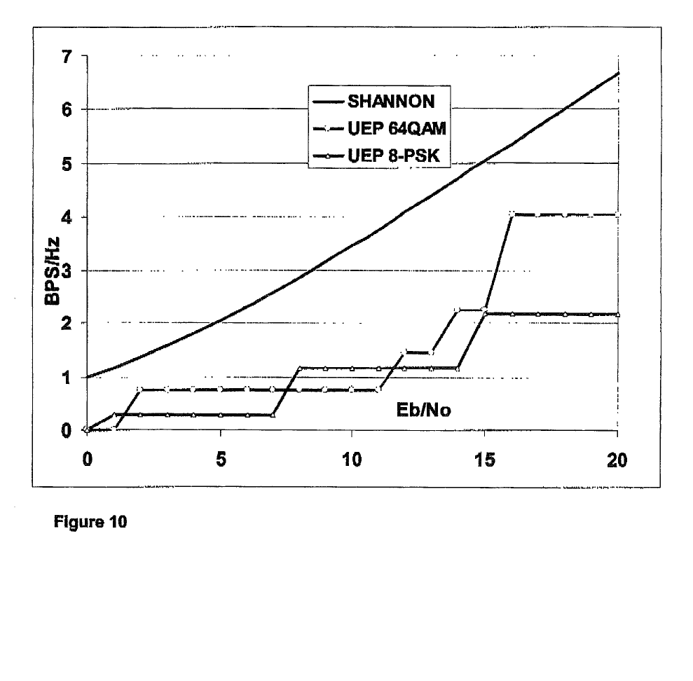

Finally, FIG. 10 shows the performance of multi-level modulation and different code strengths with re-transmission requests using 64 QAM and 8-PSK modulation. This performance is compared against the theoretical Shannon limit of data throughput in the presence of noise. The performance of such systems is generally within 3 dB of the theoretical Shannon limit.

The embodiments described above have been described with reference to transmissions within a cellular radio network. However, it will be appreciated that these techniques may be used in other radio communications applications and in wired/cabled applications.

For example, these techniques may be used to provide cable distribution systems for combined TV and data distribution with many users sharing one cable, for providing a dedicated digital subscriber loop, such as for video to the home type applications, or for a satellite downlink data system such as for internet access.

In the wireless field, the techniques may be used in a Wireless LAN system, (potentially being incorporated into future versions of the IEEE802.11 standard), for generic wireless paging or data-push applications, for infra red data communication systems, such as indoor point-to-point data communication between PDA's and desktop computers, for Bluetooth style radio communication system for interconnection of a user's various items such as mobile phones and computers, or for traditional point to point radio communications systems.

The techniques may also be used to provide a fibre optic systems to the home arranged in star or ring configuratons and generally speaking, with any system which can carry dedicated user data as well as broadcasting such as Digital Audio Broadcasting and Digital Video Broadcasting.

In addition to the modulation schemes described above, it will be appreciated that the techniques can be applied equally well to other modulations such as CDMA, OFDM (orthogonal frequency division multiplex), and Time division multiple access (TDMA) as used in some GPRS and EDGE (enhanced data rate) cellular systems due for roll-out soon.

Although it is anticipated that the QPSK modulation configuration will most commonly be used, non-Cartesian modulations, such as multiple amplitude level and phase shift keying, are also understood to be encompassed by this invention.

What is claimed is:

1. A method of transmitting data over a communications network comprising:
(a) dividing the data into a plurality of distinct data streams,
(b) modulating each data stream into a single transmission signal at different respective modulation levels, and
(c) transmitting the signal.

2. A method according to claim 1, including applying forward error correction to at least one of the data streams.

3. A method according to claim 1, wherein the modulation used is quadrature amplitude modulation.

4. A method according to claim 3, wherein each data steam is modulated using QPSK and wherein the modulated signals are combined at successively decreasing power levels to produce a composite signal for transmission over the network.

5. A method according to claim 4, wherein each successive QPSK modulation level is modulated at half the amplitude of the preceding modulation level.

6. A method according to claim 1, including waiting for an acknowledgement of received data for each data stream and re-transmitting data which is not acknowledged within a predetermined time period.

7. A method according to claim 6, wherein the data is re-transmitted in a data stream which is modulated at the same level as the original transmission.

8. A method according to claim 6, wherein the data is re-transmitted in a data stream which is modulated at a higher modulation level than the original transmission.

9. A method of receiving data over a communications network, comprising:
(a) receiving a signal over the network which carries a plurality of data streams modulated at different respective modulation levels, and
(b) demodulating a first data stream from the signal, and
(c) attempting to demodulate at least one further data stream from the signal.

10. A method according to claim 9, wherein the modulation of the radio signal is quadrature amplitude modulation.

11. A method according to claim 10, comprising demodulating the radio signal as a QPSK signal at a first assumed amplitude level, normalising the remaining signal by subtracting the decoded phase position of the demodulated first QPSK data word from the received signal and repeating the QPSK decoding and normalising steps for progressively smaller assumed amplitude levels to demodulate each said further data stream.

12. A method according to claim 9, further comprising sending an acknowledgement for each data portion of a data stream which is successfully received and demodulated.

13. A data-bearing signal comprising a plurality of QPSK modulated data streams combined into a single QAM transmission, the combination being made by combining each QPSK signal at progressively smaller amplitude levels.

14. A signal according to claim 13, wherein each additional QPSK signal is combined at an amplitude of half the preceding QPSK signal.

15. A modulator for a transmission signal comprising:
(a) a plurality of data inputs arranged to receive respective data streams,
(b) a modulator for applying modulation to the signal responsive to data received at each of the data inputs,
the modulator being arranged to apply modulation at different respective amplitude levels for data received at respective data inputs.

16. A modulator according to claim 15, wherein the modulator is arranged to apply QPSK modulation.

17. A modulator according to claim 15, wherein the modulator is arranged to apply modulation at an amplitude level which is reduced by half for data received from each successive data input.

18. A transmitter having:
(a) a plurality of data inputs arranged to receive respective data streams, and
(b) a modulator for applying modulation to a transmission signal responsive to data received at each of the data inputs,
the modulator being arranged to apply modulation at different respective amplitude levels for data received at respective data inputs.

19. A transmitter according to claim 18, arranged to receive acknowledgements of successfully received data and to re-transmit data which has not been acknowledged in a predetermined time period.

20. A transmitter according to claim 19, further arranged to re-transmit data using a different modulation level to that used for the original transmission.

21. A demodulator arranged to demodulate a signal having a plurality of data streams modulated at different respective modulation levels.

22. A demodulator according to claim 21, arranged to demodulate an QAM signal.

23. A demodulator according to claim 22, arranged to demodulate the signal as a QPSK signal at a first assumed amplitude level, to normalise the remaining signal by subtracting the decoded phase position of the demodulated first QPSK data word from the received signal and to repeat the QPSK decoding and normalising steps for progressively smaller assumed amplitude levels to demodulate each said further data stream.

24. A method of transmitting data over a communications network to a plurality of terminals comprising:
(a) modulating a signal for transmission with a plurality of respective data streams,
(b) selecting the modulation amplitude for each data stream according to the desired destination of each respective data stream, and
(c) simultaneously transmitting the data streams,
whereby the data is simultaneously transmitted to selected terminals by virtue of their differing radio channel properties and distances from the transmitter.

25. A method of transmitting data over a communications network to a plurality of terminals comprising:
(a) coding data at different code rates for plurality of respective data streams,
(b) modulating the coded data, and
(c) simultaneously transmitting the data streams,
whereby the data is simultaneously transmitted to selected terminals by virtue of their differing radio channel properties and distances from the transmitter.

26. A method according to claim 25, wherein the modulation amplitude for each data stream is selected according to the desired destination of each respective data stream.

27. A receiver including a demodulator arranged to demodulate a signal having a plurality of data streams modulated in a way which provides different susceptibility to noise.

28. A receiver according to claim 27, wherein the demodulator is arranged to demodulate a received signal modulated at different respective modulation levels for each data stream.

29. A computer program which when executed on a suitable receiver in a network causes the receiver to:
(a) receive a signal over the network which carries a plurality of data streams modulated at different respective modulation levels, and
(b) demodulate a first data stream from the signal, and
(c) attempt to demodulate at least one further data stream from the signal.

30. A computer program which when executed on a suitable transmitter in a network causes the transmitter to:
(a) divide incoming data into a plurality of distinct data streams,
(b) modulate each data stream into a single transmission signal at different respective modulation levels, and
(c) transmit the signal over the network.
